(19) United States
(12) Patent Application Publication
(10) Pub. No.: US 2009/0273195 A1
(43) Pub. Date: Nov. 5, 2009

(54) Free turn

(76) Inventor: Jerry Forrester, Brooklyn, NY (US)

Correspondence Address: Jerry Forrester;55 Winthrop Street, Apt 1 I, Brooklyn, NY, 11225, US

(21) Appl. No.: 12/317,053

(22) Filed: Dec. 18, 2008

Related U.S. Application Data
(60) Provisional application No. 61/126,015, filed on May 1, 2008.

(51) Int. Cl. E05C 1/14; E05B 1/00; E05C 1/06

(52) U.S. Cl. 292/336.3

(57) ABSTRACT

A door opening apparatus inside of a door knob or handle, includes cooperating gears transferring slidable movements from an outer member attached to the door knob, into rotational movements of an inner rotary member attached to the lock-set spindle, that cause the spindle to rotate whereby the door can be opened.

A door opening apparatus attached to the inside of a door knob or handle that will cause a door to open when the door knob or handle is pushed or pulled depending on the direction the door opens

### DESCRIPTION OF THE RELATED ART

The prior art includes U.S. Pat. No. 7,145,436 B2 discloses a door opening and closing apparatus having a motor, a door latch and a power generation mechanism, thereby using electric poet to open a door.

The prior art U.S. Pat. No. 4,838,053 discloses a heavy duty panic proof lock unit, having numerous structural reinforcements, with a lever type handle accessible by handicapped users. The prior art U.S. Pat. No. 7,273,242 B2 relates to a door knob assemble that is resistant to operation by an unauthorized person, a knob assembly that is difficult to operate through rotation of an outer knob to engage a lug with a notch to enable rotation of a spindle, when the outer knob portion is rotated.

The prior art U.S. Pat. No. 7,270,352 B1 relates to a foot-operated door opener, having a housing mounted, and hangs from a rotatable door knob or door handle and an elongated actuator extends through the housing with its upper end engaging the door knob or handle, while the actuator lower end carries a foot peal, so that the user may open a door without touching the handle.

### BACKGROUND OF THE INVENTION

The present invention relates to an apparatus contained inside lock-set knobs and handles that will enable a door to be opened, by pushing or pulling the lock-set knob or handle to open a door. The invention also includes the option to turn the knob or handle of the door first, before pulling or pushing to open a door.

The levers and handles currently in use that enables a door to be opened by pushing or pulling them, those levers or handles, when they are pushed or pulled, causes the plunger of the lock-set to slide back, releasing the lock-set plunger from the strike plate located on the door frame, opening the door. The invention does not relate to prior art having handles or levers that may be pushed or pulled to open a door, since those handles and levers cause the lock-set plunger to slide in and out from pushing or pulling, through a direct linkage linking the lock-set plunger to handles or levers, the present invention when pushed or pulled cause the lock-set spindle to turn which causes the plunger to re-track inside the lock-set embodiment. These lock-sets currently in use with handles or levers that are pushed or pulled to open a door are mostly used on screen doors, or on hospital and other commercial building doors.

The invention relates to lock-set knobs and handles that can be fitted or installed onto lock-set spindles, causing the spindles to rotate when they are pushed or pulled. The added functions to lock-set knobs and handles make opening a door much easier for persons with medical or physical problems that may have difficulties holding onto objects.

### BRIEF SUMMARY OF THE INVENTION

A door opening apparatus for installation inside of lock-sets knobs and handles and it adds to new optional functions, when opening a door, such as to push or pull the door knob to open the door without it being necessary to turn the door knob first. A lock-set having the invention also provides the option to turn the lock-set knob, before pushing or pulling, or just push or pull the knob in order to open the door, making it easier for people having difficulties holding onto objects, to open a door.

The invention comprises of an outer member, and an inner rotary member, dual purpose spring means and retaining means for keeping in palace the various elements of the invention, located inside a door knob. Door knobs having the invention will accommodate most lock-sets with a spindle, and does not change the way a door is opened, instead it adds two new functions when opening a door.

The object of the invention is to provide new options such as to push or pull the lock-set knob when opening a door. The invention is indeed new, and will be beneficial to the elderly, the handicapped, the sick, and people not able to grab or take hold of a door knob.

### BRIEF DESCRIPTION OF THE SEVERAL VIEWS OF THE DRAWINGS

The invention illustrated in the drawing in which:

FIG. 1 is a perspective view of the invention in accordance with a preferred embodiment of the present invention with a broken off portion for clarity

FIG. 2 is a perspective view of the invention with a portion cut off to illustrate the internal make-up of the various elements thereof, and showing elements not assembled, but are aligned to their respective position

FIG. 3 is a view of an alternate disassemble version of the present invention, having a transparent outer member for clarity, and contains some different elements that may function slightly different to some elements illustrated in FIG. 1 and FIG. 2

FIG. 4 is a perspective view of the assemble alternate version of the present invention, as shown in FIG. 3, illustrating a transparent portion of a door knob, containing the invention, and a cutoff portion for clarity of the various elements thereof,

### THE ELEMENTS ILLUSTRATED IN THE DRAWINGS ARE

| Outer Member | 1A |
|---|---|
| Inner Rotary Member | 2A |
| Front Beveled Gear | 3A |
| Center Beveled Gear | 4A |
| Back beveled Gear | 5A |
| Inward Coil Spring | 6A |
| Outward Coil Spring | 7A |
| Stabilizing Retainer | 8A |
| Stabilizing Retainer 8A Center Through Hole | 36 |
| Front and Back Gears Keeper | 9A |
| Front Gear 3A Track | 1 |
| Back Gear 5A Track | 3 |
| Outer Member 1A Front Gear Incurvated Slots | 2 |
| Outer Member 1A Back Gear Incurvated Slots | 4 |
| Center Gear 4A Front Side Gear Teeth | 34 |
| Center Gear 4A Back Side Gear Teeth | 35 |
| Inner Rotary Member 2A Outside Outward Step | 9 |
| Inner Rotary Member 2A Inward Outside Step | 6 |
| Front Gear Support Shaft | 10 |
| Back gear Support Shaft | 12 |
| Front Gear Inner Sleeve | 13 |
| Back Gear Inner Sleeve | 15 |
| Inward Coil Spring Elongated Ends | 14 |
| Inward Coil Spring Elongated Ends | 16 |
| Outward Coil Spring Elongated Ends | 17 |
| Outward Coil Spring Elongated Ends | 19 |
| Stabilizing Retainer 8A Lip | 18 |
| Stabilizing Retainer Trap Hole | 20 |
| Stabilizing Retainer Through Hole | 22 |
| Stabilizing Retainer Through Hole | 24 |
| Stabilizing Retainer Threaded Screws | 26 |
| Stabilizing Retainer Threaded Screws | 28 |
| Outer Member Outward End Crimping Slots - SHOW ONLY ONE | 21 |
| Inner Rotary Member Outward End Portion Female Threaded | 25 |
| Holes - SHOW ONE | |
| Inner Rotary Member Outer End Portion Inside Thread | 29 |
| Screws for Securing Inner Rotary Member Rotary Member | 31 |
| onto Lock-Set Spindle | |
| Screws for Securing Inner Rotary Member Rotary Member | 33 |
| onto Lock-Set Spindle | |
| Outer Member Outward Neck Portion Access Through Hole | 37 |
| Outer Member 1A Outward Step | 5 |

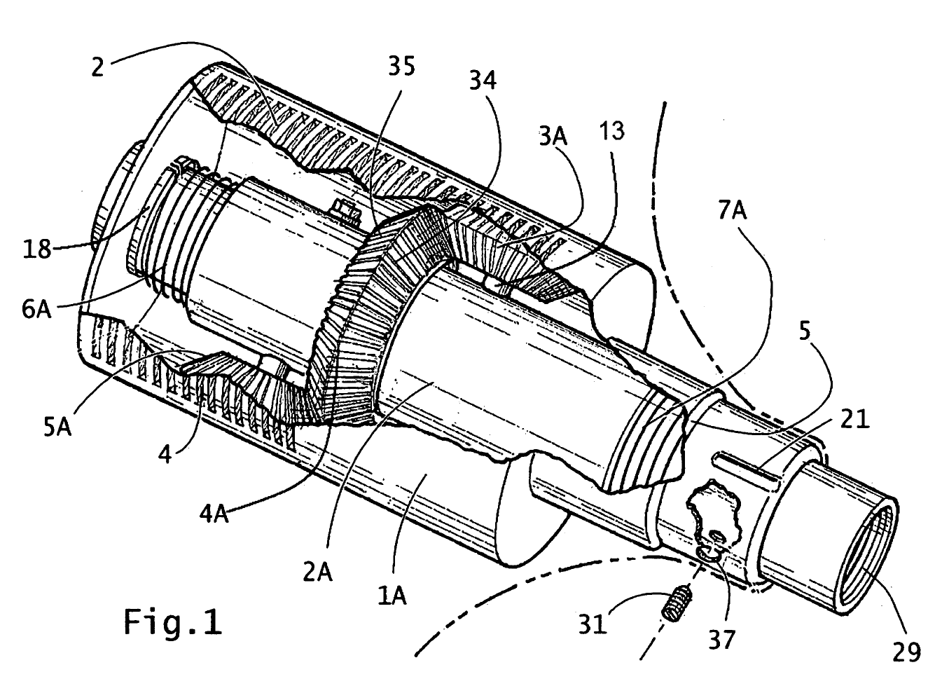

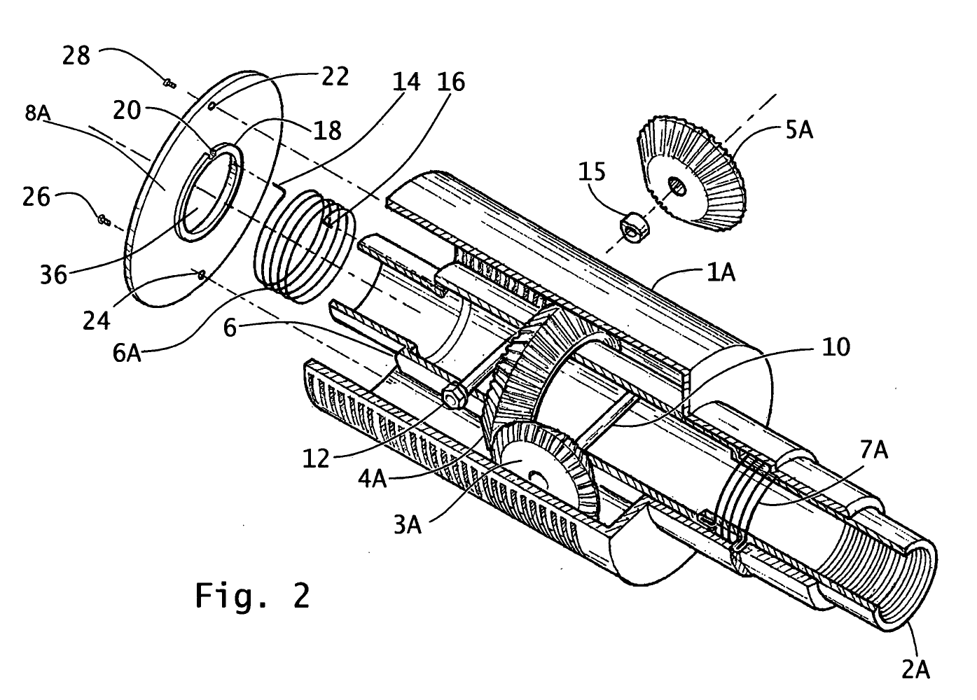

### Referring to the Drawing and More Particularly to FIGS. 1 and 2 of the Preferred Embodiment

The invention illustrated in the drawing in which:
FIG. 1 shows the invention in an assembled form with a broken off portion and showing a outer member 1A, a inner rotary member 2A, a front beveled gear 3A, a back beveled gear 5A, a center beveled gear 4A, a outward coil spring 7A, a inward coil spring 6A, a stabilizing retainer 8A,
FIG. 2 shows the present invention partially assembled illustrating various elements aligned to their respective positions in which back gear 5A, inner sleeve 15, inward coil spring 6A, coil spring 6A inward elongated end 14, coil spring 6A outward elongated end 16, stabilizing retainer 8A, retainer 8A through holes 22, 24 and 36 retainer 8A having lip 18 and slot 20, and threaded screws 26 and 28, FIG. 2 further illustrates front gear 3A and support shaft 10 back gear 5A and support shaft 12 support shaft 10 and 12 stabilizing sleeves 15 and 13 as shown in FIG. 1 for accommodating, cooperating and communicating with front gear 3A and back gear 5A inner member 2A inward step 6 and outward coil spring 7A

### DETAILED DESCRIPTION

Referring now to the drawing in which FIG. 1 shows a partial outline of a door knob neck portion secured onto the present invention outward neck portion by way of crimping, not shown; the door knob neck onto slots 21 and another slot not shown in the drawing, located on the outer member 1A outward neck portion, the outer member 1A includes two parallel series of incurvated slots 2-4 extending from its inward end to approximately two thirds towards the distance towards its outward end, for communicating with the front beveled gear 3A and the back beveled gear 5A. The outer member 1A further includes an inside outward step 5 with trap hole not shown in the drawings, the outer member 1A include an access through hole 37 to access the female threaded hole 25 and another hole not shown in the drawings, located through the outward neck portion of the rotary member 2A for screws 31-33 to thread onto the lock-set spindle, the outer member 1A inward end having to female threaded holes not shown in the drawings whereby the stabilizing retainer ring 8A is fixedly secured to the outer member 1A with screws 26-28,

The inner rotary member 2A shows the outward step 9 with the trap hole not shown in the drawings on the outside outward neck portion thereof. The outer member 1A shows the outward step 5 with trap hole not illustrated in the drawings. The outward step 5 and 9 with trap holes not shown in the drawings, accommodate each other and keep in place the outward coil spring 7A with elongated ends 17 and 19 whereby the outer member 1A and inner rotary member 2A slidable and rotational movements is permitted and reversible from the outward coil spring 7A reactionary movements, the inner rotary member 2A include the inward outside step 6 with trap hole not shown in the drawing to accommodate the inward coil spring 6A with elongated ends 14-16 for cooperating with the stabilizing retainer 8A. The inner rotary member 2A outward inside end portion shows the female threaded hole 29, for screwing onto the lock-set spindle. The center beveled gear 4A slide on and is fixedly secured approximately one third of the distance from the inward end of the inner rotary member 2A. The front beveled gear 3A, is secured on a pivot passing through the inner rotary member 2A, in front or on the outward side of the center beveled gear 4A. The back beveled gear 5A, is secured on the pivot passing through the inner rotary member 2A inward or back side, of the center beveled gear 4A. The front beveled gear 3A meshes with the center beveled gear 4A, outward face side front teeth 34, and the outer member 1A, front gear incurvated slots 2, while the back beveled gear 5A meshes with the center beveled gear 4A inward side back teeth 35 and the outer member 1A back gear incurvated slots 4, whereby slidable movements of the outer member 1A relative to the inner rotary member 2A will rotate the front beveled gear 3A and the back beveled gear 5A causing the engaged center beveled gear 4A to rotate, rotating the attached inner rotary member 2A which shall rotate an attached lock-set spindle enabling a door to be opened from slidable movements of the outer member 1A relative to the inner rotary member 2A,

The stabilizing retainer 8A shows the center through-hole 36 having a rim-like lip 18 with the trap hole 20 and two through-holes 22 and 24. The inward coil spring 6A seats on the inner rotary member 2A inward end portion step 6 and the stabilizing retainer 8A through hole 36 fits on the inner rotary member 2A inward step 6 so as to enable screws 26 and 28 to secure the stabilizing retainer 8A to the outer member 1A inward end. The stabilizing retainer 8A outer holes 22 and 24 are aligned with the outer member 1A inward end threaded holes not shown thereof. The inward coil spring elongated ends 14 and 16 fits into, and is thereby trapped in the inner rotary member 2A inward step 6 trap hole 8 not shown, and in the stabilizing retainer 8A trap hole 20 whereby slidable and rotational movements of the outer member 1A relative to the inner rotary member 2A will be reversed, turning the outer member 1A to its original position, relative to the inner rotary member 2A.

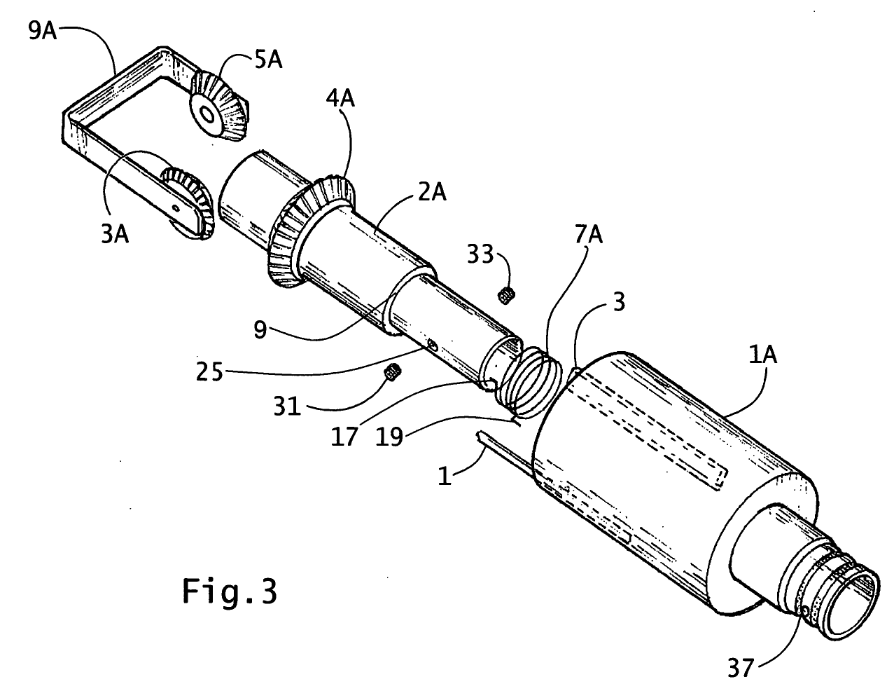

### FIG. 3 Alternative Apparatus

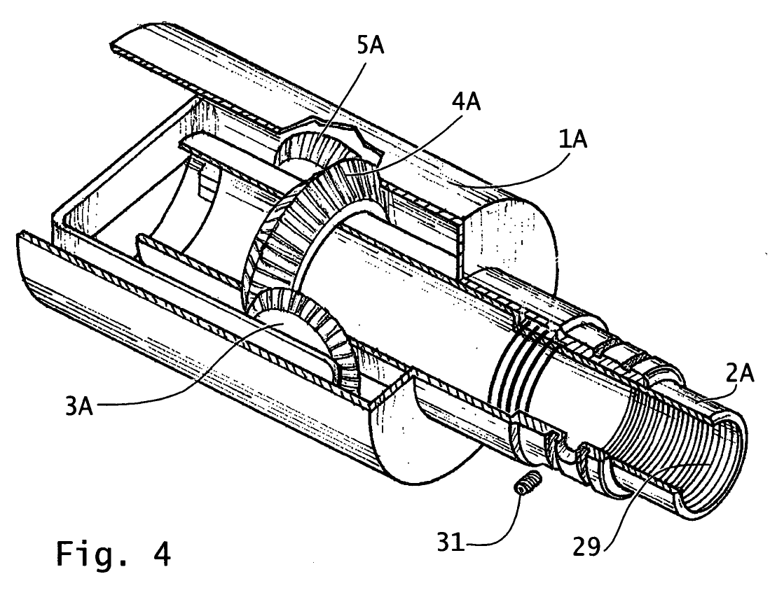

There are various alternatives with regards to the relative disposition of the gears and its mating members and the retaining members, such as the stabilizing retainer 8A inward end of the apparatus illustrated in FIG. 1 and the keeper 9A for the gears as shown in FIG. 3 and FIG. 4. The gears mating track 1 and 3, shown secured onto the inside horizontal wall of the outer member 1A, illustrated in FIG. 3 and FIG. 4, which presents perspective views of the invention having the outer member 1A shown in a transparent form with a portion cut off for clarity, FIG. 4 showing an alternative version of the invention assembled and comprising the transparent outer member 1A, three cooperating beveled hears 3A, 4A and 5A, a outward coil spring 7A with elongated ends 17 and 19, a inner rotary member 2A having a through-hole horizontally aligned and contain an open outward end with internal female thread 29 and a inward open end. The outward open end internal female thread 29 is for attachability onto lock-set spindles. The outward end portion including a outward step 9 with trap hole not shown in the drawings that cooperate with the outer member 1A, outward neck portion inside step 5 with trap hole not shown in the drawings. The inner member 2A outward step 9 with trap hole cooperate with the outer member 1A outward end portion inside step 5 with trap hole 7 for keeping the coil spring 7A with elongated ends 17 and 19 in a functional position. FIG. 3 and FIG. 4 illustrate a gear keeper 9A having a long end and a short end, and free turn as illustrated in FIG. 3. The three beveled gears including the front beveled gear 3A, the back beveled gear 5A. The center beveled gear 4A is fixedly secured on an inward portion of the inner rotary member 2A, the front and back beveled gears 3A and 5A are mounted on either end of the gear keeper 9A long and short ends, the assembled apparatus as shown in FIG. 3 having the front and back gears 3A and 5A positioned so that the front beveled gear 3A will mesh with the outward face side of the center beveled gear 4A and the back beveled gear 5A will mesh with the inward back side of the center beveled gear 4A. The outer member 1A shows two gear tracks 1 and 3, attached to the underside of the outer member 1A inward portion thereof. The gear tracks 1 and 3 are positioned to permit partial rotation of the outer member 1A relative to the front gear 3A and the back gear 5A and to mesh with the front beveled gear 3A and the back beveled gear 5A, whereby sliding of the outer member 1A, relative to the inner rotary member 2A, and the front and back beveled gears 3A, and 5A, transmit rotation to the center beveled gear 4A that is secured on the inner rotary member 2A, thereby rotating the inner rotary member 2A, and the inner rotary member 2A in turn rotate the lock-set spindle whereby the apparatus enables a person to open a door by simply pushing or pulling the lock-set knob
As illustrated in FIG. 3

The outer member 1A shows two gear tracks 1 and 3 aligned to be attached to the underside of the outer member 1A inward portion thereof, and the gear keeper 9A long end and short end are positioned to keep in place the front beveled gear 3A and the back beveled gear 5A, in the position so as to mesh with gear tracks 1 and 3, whereby sliding of the outer member 1A relative to the inner rotary member 2A and the three cooperating beveled gears 3A and the back beveled gear 5A and said front and back beveled gears 3A and 5A transmit rotation to the center beveled hear 4A, that is secured on the inner rotary member 2A, thereby rotating the inner rotary member 2A, and the inner rotary member 2A in turn rotate the lock-set spindle whereby the apparatus enables a person to open a door by simple pushing or pulling the lock-set knob

### DETAILED DESCRIPTION OF THE INVENTION

New and improved door knobs and handles for lock-sets:
The present invention relates to a new and improved door opening apparatus that will cause a door to open from pulling or pushing onto a door knob or handle, the option to turn remains.
The invention includes to cylindrical members; a inner rotary member and the outer member, three cooperating gears, urging means, and means retaining the various elements inside a lock-set knob and handle and may extend outward to fit onto the lock-set spindle.
The outer member may slide back and forth over the inner rotary member and are prevented from sliding off the inner rotary member by retaining rings or other trapping means, such as the step shown in the accompanying drawings.
The inner rotary member contains through-holes having thread and lock screws; it may slide or screw onto a lock-set spindle, and are kept in place by tightening the lock screws.
The outer member contains a access hole aligned with the inner rotary member threaded through-holes and lock-screw thereof, thereby leaving access to tighten or loosen the lock-screws. The outer member may have ridges, grooves or slots located on its inside wall, that will cooperate with gears, located towards the inward end of the inner rotary member. The outer member also contain annulus retaining means located towards its inside outward end for keeping the inner rotary member in place with the help of a snap ring not included in the drawings or other suitable retaining means. The inner rotary member may contain two threaded holes, for accommodating the lock screws used to hold it in place. The inner rotary member may also contain a annulus retaining outward tapered end, or groove located on it outward end. The inner rotary member may accommodate two gears, located towards its inward end. The gears are front and back gears, and they are in contact with the outer member ridges, grooves or slots, and they transmit sliding movements from the outer member into rotational movements of a third center gear, mounted onto the inner rotary member that cause the rotation of the inner rotary member which can rotate a attached lock-set spindle.

### Description of the Preferred Embodiment

The invention relates to an apparatus for inside lock-set knobs and handles to enable a door to be opened by pushing or pulling the knob or handle of a door lock-set. The option to turn then push or pull a lock-set knob or handle in order to open a door still remains. Prior art does not contain such apparatus inside of lock-set knobs or handles, for the purpose of opening doors. The invention includes an outer member having an outward end and an inward end. The outer member outward end contains an opening, as shown in the drawing, through which the inner rotary member outward end may pass thereof. The outer member also contains a beveled portion of its inside wall as shown on the drawing, for keeping in place the inner rotary member and dual purpose coil spring with elongated ends. The outer member provides two openings towards its outward end or neck as passage for set screws to pass through and thread into the inner rotary member outward end or neck portion onto a lock-set spindle. The outer member outward end or neck area contains a grooved or slot portion for gripping or crimping a door knob neck portion onto the outer neck portion of the outer member as shown in the drawing. The outer member also includes two series of slots towards its inward end area, as shown in the drawing, that cooperate with two gears namely front and back gear. The invention also includes the inner rotary member that fits into the outer member. The inner rotary member step portion contains a trap hole as shown in the drawing for preventing the dual purpose coil spring from turning independent of the inner rotary member. The inner rotary member inward portion outer circumferential wall having means to keep in place a center gear with means to be fixedly secured onto the inner rotary member, and the inner rotary member contains two through-holes, front and back, that accommodate holding means for two gears front and back, and they cooperate with the outer member and the center gear, transmitting movements from the outer member to the center gear that transfer movements to the inner rotary member, causing the turning of a lock-set spindle, that cause a lock-set plunger to retract to open a door.
In a door knob and handle comprising:

What I claim as my invention is:

1. A door opening apparatus fixedly secured inside door knobs and handles, said apparatus having accommodating means for installation onto lock-set spindles thereby enabling said apparatus to cause rotation of said spindle by converting slidable movements of said apparatus into controllable rotational movements enabling said door to open by pushing said door knob providing said door swing outward; and pulling providing said door swing inward, the option to rotate said door knob before pulling or pushing in order to open said door remains,
said door opening apparatus comprising:
(a) a outer member
(b) a inner rotary member
(c) a plurality of rotary means
(d) a plurality of retaining means
(e) urging means
(f) transmitting means
said plurality of rotary means, are in communication with the inner rotary member configured as to accommodate and cooperate with said plurality of rotary means and said urging means are positioned to react to movement of said outer member relative to said inner rotary member, and the plurality of retaining and stabilizing means adapted to, functions in accommodating and keeping in place the various elements of said apparatus,

2. The door opening apparatus of claim 1 wherein said inner rotary member is cylindrical with two sized down end portion or steps and include an open outward end and a open inward end, said open outward end having female thread, thereof, to mate with said spindle with said spindle male thread, said outer member having a cylindrical form and an open outward end and an open inward end and said outer member inward open end rim portion includes two female threaded holes on opposite ends of said inward open end rim portion adapted to accommodate two threaded screws to keep in place a stabilizing retainer, said outer member including an elongated neck portion of said door knob to fixedly secure onto, said outer member elongated neck portion include a outward inside step with trap hole, said inner step prevent portions of said rotary member from sliding through while permitting other predetermined portion of said inner rotary member to slide to and fro, said inner step impose a seat for a coil spring with elongated ends and said inner step trap hole accommodates one of said coil spring elongated ends, said outer member includes slot means for cooperating with a front beveled gear and a back beveled gear, said transmitting means include a plurality of slots positioned to engage and transfer slidable movements of said outer member, relative to said plurality of rotary means, to rotational movements of sail plurality of rotary means, said slots having parabolic form and allow for a clearance between two slides of said slots and said front and back beveled gears whereby said outer member can rotate relative to said plurality of rotary means for predetermined distance up until one side of said plurality of rotary means reach a side of said parabolic slots enabling said outer member to then include said plurality if rotary means, in said outer member rotation thereof, whereby said door knob can be rotated also in order to open said door

3. The door opening apparatus of claim 1 wherein said plurality of rotary means accommodating means are parabolic slots slightly wider than that of the front and back beveled gears whereby a clearance on both sides of said gears and slots sides thereof enabling said front and back beveled gears to permit said slot to free turn up to and against end of one side of said slot,

4. The door opening apparatus of claim 1 wherein said plurality of rotary means comprising: three cooperating beveled gears, the center beveled gear, the front beveled gear and back beveled gear, said front beveled gear and said back beveled gear are positioned on the same place and are in engagement with said outer member and said parabolic slots, and said front gear meshes with said center gear outward face side and said back gear meshes with said center gear inward back side wherein slidable movements of said outer member relative to said inner rotary member and said gears cause said parabolic slots to rotate said front beveled gear and said back beveled gear and said front and back beveled gear rotates said center beveled gear in the same direction causing said inner rotary member to rotate, rotating said lock-set spindle whereby said door can be opened by pushing or pulling said opening apparatus,

5. The door opening apparatus of claim 1 wherein said inner rotary member accommodating means includes two through-holes, positioned pass the center point inward, for attaching of said front and back beveled gears support member, thereof, said support members include two spacers each having an inward curved end and the flat outward end, said spacers having two through-holes for passage of two bolts with threaded ends, said bolts mate with two threaded nuts whereby said front beveled gear and said back beveled gear can be fixedly secured on a pivot, said inner rotary member further including a predetermined portion between said through holes for keeping fixedly secured said center beveled gear thereof, whereby said front beveled gear meshes with said center beveled gear outward side and said back beveled gear meshes with said center beveled gear inward side whereby rotations of said front beveled gear and said back beveled gear, rotates said center beveled gear in the same rotational direction, said inner rotary member accommodating means further including to steps around its outer circumferential wall close to each end, said steps each having a trap hole thereof, said steps and trap hole includes an outward step with trap hole and an inward step with trap hole, and said steps prevent over travel of said outer member, relative to said inner rotary member, and accommodate and keep in place said coil spring with elongated ends, and said trap hole accommodate said coil spring elongated end said outward step portion and said inward step portion are smaller in outside diameter than the rest of said rotary member body, said outward step and said inward step each furnishes a seat for said coil springs and said trap holes accommodate said coil spring elongated ends, said inner rotary member and said accommodating means further include a outward open threaded hole for attachability onto said lock-set spindles whereby rotation of said inner rotary member can be transferred to said lock-set spindle

6. The door opening apparatus of claim 1 wherein said plurality of said retaining and stabilizing means further including a stabilizing retainer having a front face side and a back side, and said retainer ring having two holes positioned towards the outer rim portion and said holes are on opposite ends of said stabilizing retainer, and are aligned with said female threaded holes on said outer member said inward end, said retainer ring comprise a stabilizing hole surrounding wall elongated, which form a lip over which said coil spring encircles and rest thereon, said stabilizing retainer having trap hole positioned through said stabilizing retainer flat surface and close to the outer wall of said stabilizing retainer said lip, said stabilizing retainer lip and trap hole accommodate and keep in place said coil spring with elongated end respectively,

7. The door opening apparatus of claim 1 wherein said inner member said inward and outward step portions are sized so as to enable said coil spring to slide over and around up to said steps and said trap holes accommodates said spring elongated ends,
Said inner rotary member inward step portion are positioned to enable said stabilizing retainer to stabilize and cooperate with said inner rotary member step portion,

8. The door opening apparatus of claim 1 wherein said retaining and stabilizing means further including the stabilizing retainer having the elongated lip surrounding the through hole at its center; and the trap hole thereof, said stabilizing retainer including a outward face side with elongated lip around said center through hole, and two through holes positioned on opposite ends of the circumference rim, and said two through holes permits passage of two screws for fastening said stabilizing retainer to said outer member, and said stabilizing retainer center hole permit slidable movements of said stabilizing retainer relative to said inner rotary member, and said stabilizing retainer keep in place said inner rotary member whereby pushing or pulling onto said door knob cause said outer member said engageable slots to slide on said front beveled gear and said back beveled gear rotating said front and back gears which rotates said center beveled gear in a uniform direction, and said center beveled gear rotates said inner rotary member, and said inner rotary member rotates said lock-set spindle, enabling said door to be opened by pushing or pulling onto said knob, the option to rotate said knob before pushing or pulling to open said door remains,

9. A door handle opening apparatus comprising:
(a) a outer member having a plurality of mating means for mating with,
(b) a plurality of rotary means for converting slidable movements of said outer member into rotational movements,
(c) a inner rotary member that transfers rotational movements to a lock-set spindle
(d) said outer member, having an open outer end for accommodating and cooperating with said inner rotary means whereby slidable movements of said outer member relative to said inner member will turn said rotary means and said rotary means will rotate said inner rotary member thereby rotating said spindle opening the door said apparatus having urging means for re-tracking said outer member and inner member slidable movements and reversing rotational movements of said inner rotary member, said apparatus comprise retaining and stabilizing means for keeping in place the various elements of said apparatus,

10. The door opening apparatus of claim 2 wherein said outer member having a cylindrical form and can be made from a combination of durable materials,

11. The door opening apparatus of claim 2 wherein said outer member further including a plurality of gear tracks wherein said gear tracks cooperate with said rotary means,

12. The door opening apparatus of claim 2 wherein said outer member having a outward step containing a trap hole located on the inside neck portion of said outer member and said step furnishes a seat for said coil spring, and coil spring elongated end and, enabling said spring to reverse any rotational movements of said outer member relative to said inner rotary member,

13. The door opening apparatus of claim 2 wherein said outer member outside neck portion having means securing said door knob inside neck portion thereof,

14. The door opening apparatus of claim 2 wherein said outer member comprise two female threaded holes located on its inward end rim for holding in place said stabilizing retainer, and said stabilizing retainer position thereof with fastening means, such as screws,

15. The door opening apparatus of claim 2 wherein said stabilizing retainer comprise a center aperture with an elongated lip and a off centered trap hole, said stabilizing retainer keep in place said spring which seat around said lip and said elongated spring end extend into said off center trap hole,

16. The door opening apparatus of claim 2 wherein said stabilizing retainer said aperture is aligned for and accommodate said inner rotary member inward end portion, wherein said lip is surrounding said end portion of said inner rotary member,

17. The door opening apparatus of claim 2 wherein said rotary means includes two beveled gears mounted on the opposite sides of said inner rotary member and are sandwiching said inner rotary member rotary means,

18. The door opening apparatus of claim 2 wherein said inner rotary member having a inward end and a outward open end, said inner rotary member outward end portion contain a step with a trap hole for said spring and said elongated end thereby enabling said spring to reverse slidable and rotational movements of said inner rotary member relative to said outer member,

19. The door opening apparatus of claim 2 wherein said inner rotary member said inward end portion contain a step with a trap hole for keeping in place said spring thereby enabling said spring to reverse slidable and rotational movements of said outer member relative to said inner rotary member said spring will return said outer member to its original position relative to said inner rotary member,

20. The door opening apparatus of claim 2 wherein said inner rotary member rotary means is a center beveled gear mounted thereon and is fixedly secured approximately on third of the distance from the inward end of said inner member outside diameter, said center beveled gear is sandwich, front and back by said beveled gears mounted on opposite sides of said inner rotary member thereby meshing and cooperating with said outer member gear tracks whereby pushing or pulling said door handle will cause said outer member to slide to and fro relative to said inner rotary member thereby turning said beveled gears mounted on opposite sides of said inner rotary member and said front and back beveled gears will rotate said center beveled gear mounted on said inner rotary member whereby said inner rotary member will rotate, rotating said spindle, enabling a door to open,

21. A door opening apparatus configured to be fixedly secured inside said door knob and onto a lock-set spindle in order to rotate said lock-set spindle, by pushing, pulling or turning said door knob containing the present invention, the apparatus including
A outer member having an open outward end and an open inward end and accommodating and retaining means on said outer member inside and outside circumferential walls, said outer member inside wall accommodate a plurality of engageable means for the purpose of mating with a plurality of cooperating rotary means positioned as to cooperate with a inner rotary member having an open outward end and an open inward end, said inner rotary member open outward end having accommodating means for attachability onto said lock-set spindle, said inner rotary member outside circumferential wall accommodating and retaining means is for keeping in place the various elements of said apparatus, urging means for counter movements of said outer member relative to said plurality of cooperating rotary means and said inner rotary member respectively,
A keeper having means for attachability of said plurality of cooperating rotary means, and for keeping in a functionable position, said plurality of rotary means, whereby slidable movements of said outer member and the plurality of said engageable means relative to said plurality of cooperating rotary means and said inner rotary member, rotates said plurality of cooperating rotary means which in turn rotates said inner rotary member whereby said inner rotary member can rotate said lock-set spindle in order to open a door,

22. The door opening apparatus of claim 2 wherein said door opening apparatus, configured as to be fixedly secured inside said door knob include a outward outside elongated neck portion having two slots for attachability of said door knob thereof, and the said inner rotary member outward open end having female threaded means for attachability onto said lock-set spindle, said door opening apparatus retaining means include a female threaded through-hole and a screw positioned close to the outward end of said apparatus for gripping of said lock-set spindle,

23. The door opening apparatus of claim 2 wherein said outer member having a cylindrical form with an elongated neck portion and includes an inner step with a trap hole on the inside circumferential wall thereof, for permitting said inner rotary member to rotate relative to said outer member and to permit a portion of said inner rotary member to slide to and fro inside said outer member while preventing said inner rotary member step portion from sliding pass the outer member step portion and for said coil spring with its elongated end projecting into said outer member inside step portion trap hole,

24. The door opening apparatus of claim 2 wherein said outer member inside wall accommodate plurality of engageable means which include two geared tracks positioned so as to mesh with said plurality of cooperating rotary means wherein sliding to and fro of said outer member with said two geared tracks relative to said plurality of cooperating rotary means and said inner rotary member rotates said inner cooperating rotary means which in turn rotate said inner rotary member enabling said inner rotary member to rotate said lock-set spindle whereby said door can be opened,

25. The door opening apparatus of claim 2 wherein said plurality of cooperating rotary means including three beveled gears positioned so as to convert sliding movements of said outer member with geared tracks into rotational movements of said beveled gears and said beveled gears are a front beveled gear, a center beveled gear and a back beveled gear, all three said beveled gears cooperate to convert slidable movements of said outer member with geared tacks to rotation of said inner rotary member and said inner rotary member inward end portion approximately a quarter of the distance from the inward end, and said beveled front gear and said beveled back gears are kept in place by way of said keeper thereby enabling said front beveled gear to be positioned in front of said center beveled gear and meshes thereof and said back beveled gear to be positioned behind said center beveled gear and meshes thereof whereby said front beveled gear and back beveled gear can rotate from sliding movements said outer member with geared tracks rotating said center beveled gear in the same direction enabling said center beveled gear to rotate said inner rotary member which rotate said lock-set spindle to open said door,

26. The door opening apparatus of claim 2 wherein said inner rotary member accommodating means include a female threaded outward inside end portion hole horizontally positioned so as to be mounted onto said lock-set spindle, and said outward end portion having a vertically positioned female threaded hole for a screw to mate into and onto said lock-set spindle so as to enable said inner rotary member to be fixedly secured onto said lock-set spindle,

27. The door opening apparatus of claim 2 wherein said urging means for counter movements include a coil spring having elongated ends said coil spring reverse functions resulting from external exerted force such as pushing, pulling, and rotating, whereby after opening said door said apparatus various elements will return to their original position,

28. The door opening apparatus of claim 2 wherein said inner rotary member accommodating and retaining means include the inner rotary member having a outward step with trap hole positioned towards the outward end portion of the outer circumferential wall thereof, said inner rotary member outward step with trap hole and said outer member outward inside circumferential wall step with trap hole cooperate to permit sliding of the outer member relative to the inner rotary member and keep in place said coil spring with elongated ends whereby said door knob can be pushed, pulled, or rotated in order to open said door,
